(19) United States
(12) Patent Application Publication
(10) Pub. No.: US 2021/0387515 A1
(43) Pub. Date: Dec. 16, 2021

(54) VEHICLE ENTRANCE SYSTEM AND METHOD FOR CONTROLLING THE SAME

(71) Applicant: Hyundai Motor Company, Seoul (KR)

(72) Inventors: Sang Heon LEE, Seoul (KR); Jin Ho HWANG, Cheonan-si (KR); Dong Eun CHA, Hwaseong-si (KR)

(73) Assignee: KIA Motors Corporation, Seoul (KR)

(21) Appl. No.: 17/036,750

(22) Filed: Sep. 29, 2020

(30) Foreign Application Priority Data
Jun. 12, 2020 (KR) 10-2020-0071681

(51) Int. Cl. B60J 5/02; E05F 15/00; E05F 15/73

(52) U.S. Cl. CPC B60J 5/02; E05F 15/00; E05F 15/73; E05Y 2900/531; E05Y 2400/44; E05Y 2400/45; B60G 2500/30

(57) ABSTRACT

A vehicle entrance system includes: an upper gate configured to open and close an upper portion of a vehicle entrance through a sliding operation or a rotational operation; and a lower door provided at a lower portion of the vehicle entrance and configured to close the lower portion of the vehicle entrance or be stretched from the lower portion of the vehicle entrance to the outside to provide an entrance/exit guide panel extending from a floor of the vehicle.

### CROSS REFERENCE TO RELATED APPLICATION

The present application claims priority to Korean Patent Application No. 10-2020-0071681, filed Jun. 12, 2020, the entire contents of which is incorporated herein for all purposes by this reference.

### TECHNICAL FIELD

The present disclosure relates to a vehicle entrance system in which an entrance of the vehicle is divided into an upper side and a lower side that are controlled to be opened and closed independently such that a seat of the vehicle or a mobile object can freely enter and exit the vehicle to be loaded or unloaded, and a method for controlling the same.

### BACKGROUND

As vehicles have become motorized and autonomous, the interior structures of vehicles have changed in many aspects. In particular, a concept of a seat of a vehicle being removable and used as a mobile object while being rotatable when located within the interior of the vehicle has been considered.

Meanwhile, in recent years, through a concept of last-mile technology, various personal mobile object devices have been mass-produced and shared, and thus technology of a personal mobile object entering and exiting the vehicle is being considered.

That is, various objects ranging from an ultra-small mobile object to a seat of the vehicle, as well as a passenger, enter and exit the vehicle, so it is necessary to change doors of the vehicle.

The items described as the background technologies are provided only for improvement of understanding of the background of the present disclosure, and should not be understood that it is admitted that the items correspond to the conventional technology that is known to those skilled in the art to which the present disclosure pertains.

### SUMMARY

The present disclosure has been made in an effort to solve the above-mentioned problems, and provides a vehicle entrance system in which an entrance of the vehicle is divided into an upper side and a lower side that are controlled to be opened and closed independently and a seat of the vehicle or a mobile object can freely enter and exit the vehicle to be loaded or unloaded, and a method for controlling the same.

In accordance with an aspect of the present disclosure, a vehicle entrance system includes: an upper gate configured to open and close an upper portion of a vehicle entrance through a sliding operation or a rotational operation; and a lower door provided at a lower portion of the vehicle entrance and configured to close the lower portion of the vehicle entrance or be stretched from the lower portion of the vehicle entrance to the outside to provide an entrance/exit guide panel extending from a floor of the vehicle.

The lower door may be stretched and the upper gate and the lower door may be opened and closed simultaneously or independently to allow an object to enter the inside of a vehicle or to exit to the outside through the lower door.

An area of the upper gate may be larger than an area of the lower door.

The upper gate may be connected to an edge of the vehicle entrance through a link and the upper portion of the vehicle entrance may be opened and closed through rotation and sliding of the link.

A lower end of the lower door may be hinge-connected to a lower end of the vehicle entrance and the lower portion of the vehicle entrance may be opened and closed through rotation of the lower door.

The lower door may be provided with a detection sensor, the detection sensor may measure a spacing distance between the lower door and a ground surface, and an opening degree of the lower door may be controlled according to a measurement result of the detection sensor.

The lower door may provide an entrance/exit guide panel extending from the floor of a vehicle, and an inclined surface extending from the floor of the vehicle to a lower side of the outside may be defined by the entrance/exit guide panel as an upper end of the lower door approaches the ground surface or is supported by the ground surface when the lower door is opened.

The vehicle entrance system may further include a controller configured to control the upper gate and the lower door to be opened together or independently.

The controller may control a road clearance of the vehicle by comparing a height of a connection point of the lower door and a vehicle body and a height of the ground surface.

The controller may authenticate an object and control the lower door to be opened when the object is permitted for entrance or exit.

The controller may determine whether to open the upper gate according to the kind of the object or an authentication result.

When a size of the object on the outside is a predetermined size or less, the controller controls the upper gate to be maintained closed and the lower door to be opened.

When the size of the object is a predetermined size or more, the controller may open the upper gate and adjust an opening degree of the upper gate according to the size of the object outside of the vehicle.

The vehicle entrance may be provided on a front surface of a vehicle.

In accordance with another aspect of the present disclosure, a method for controlling the vehicle entrance system includes: detecting a request for entrance of an object; determining whether the upper gate or the lower door is opened according to the kind of the object that is permitted for entrance and exit or the kind of detected information; and controlling opening and closing of the upper gate or the lower door.

The determining of whether the upper gate or the lower door is opened may include determining whether the upper gate is opened, whether the lower door is opened, and an opening degree when the upper gate is opened.

According to the vehicle entrance system and the control method of the present disclosure, the entrance of the vehicle is divided into an upper side and a lower side, which are controlled to be opened and closed independently and the seat of the vehicle or the mobile object can freely enter and exit the vehicle to be loaded or unloaded.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view of a vehicle entrance system according to an embodiment of the present disclosure;

FIG. 2 is a conceptual view of the vehicle entrance system according to the embodiment of the present disclosure;

FIG. 3 is a view of the lower door according to the embodiment of the present disclosure;

FIGS. 4 and 5 are views of a utility state of the vehicle entrance system according to the embodiment of the present disclosure;

FIG. 6 is a view illustrating a process of adjusting a road clearance for a vehicle of the vehicle entrance system according to the embodiment of the present disclosure; and

FIG. 7 is a flow chart of a method for controlling the vehicle entrance system according to the embodiment of the present disclosure.

### DETAILED DESCRIPTION OF THE EXEMPLARY EMBODIMENTS

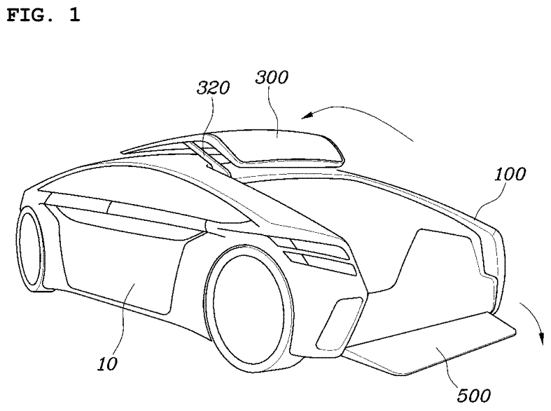

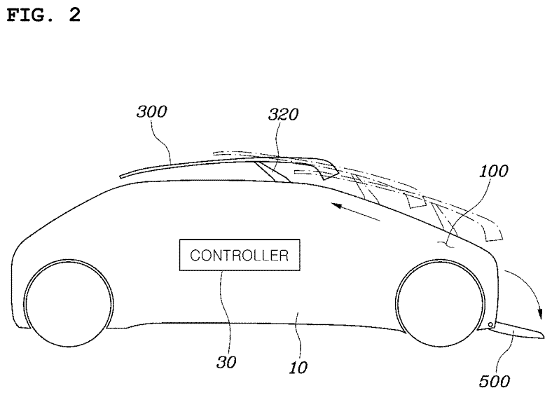

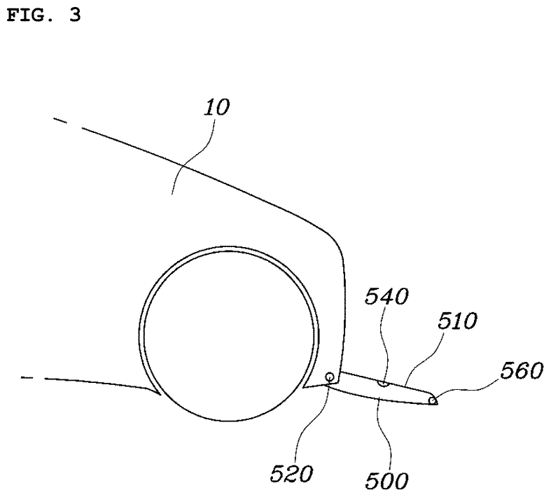

FIG. 1 is a perspective view of a vehicle entrance system according to an embodiment of the present disclosure. FIG. 2 is a conceptual view of the vehicle entrance system according to the embodiment of the present disclosure. FIG. 3 is a view of the lower door according to the embodiment of the present disclosure.

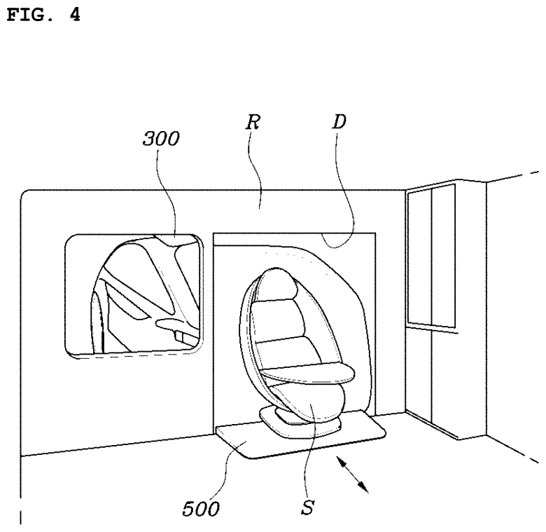

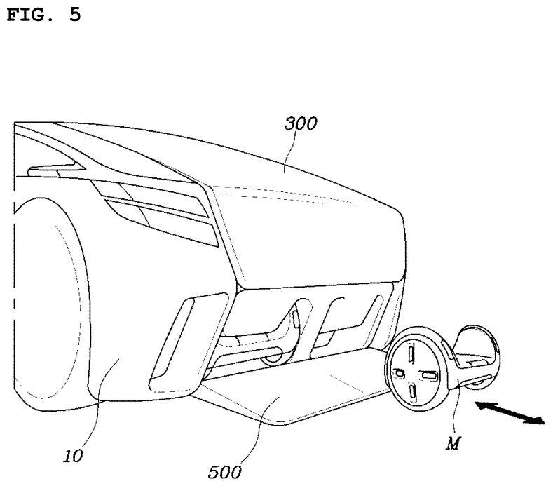

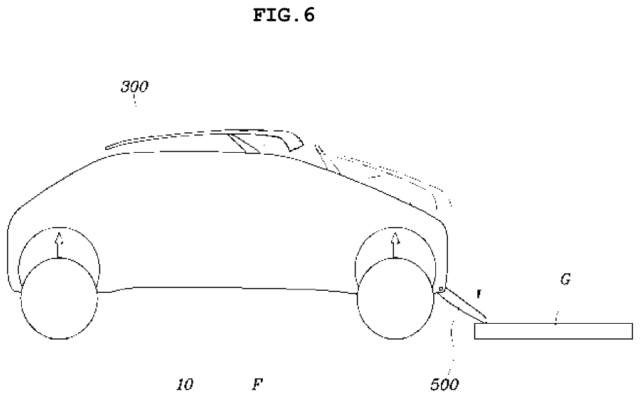

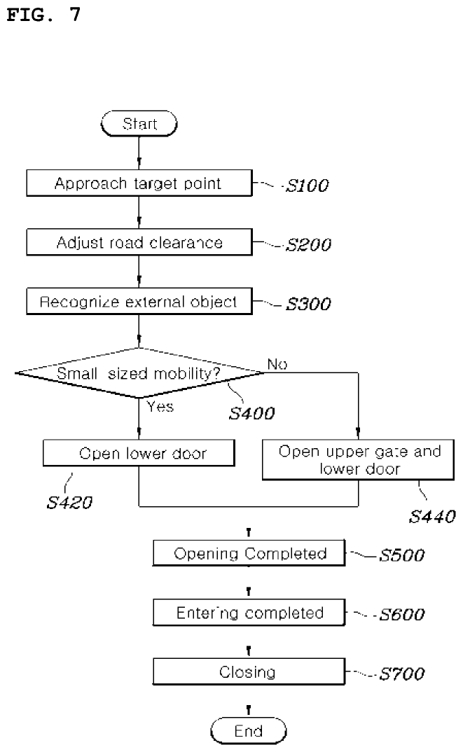

FIGS. 4 and 5 are views of a utility state of the vehicle entrance system according to the embodiment of the present disclosure. FIG. 6 is a view illustrating a process of adjusting a road clearance for a vehicle of the vehicle entrance system according to the embodiment of the present disclosure. FIG. 7 is a flow chart of a method for controlling the vehicle entrance system according to the embodiment of the present disclosure.

FIG. 1 is a perspective view of a vehicle entrance system according to an embodiment of the present disclosure. The vehicle entrance system according to the present disclosure may include: an upper gate 300 configured to open and close an upper portion of a vehicle entrance 100; through a sliding operation or a rotation operation, a lower door 500 provided at a lower portion of the vehicle entrance 100 and configured to close a lower portion of the vehicle entrance 100 when being received or stretched from the lower portion of the vehicle entrance 100 to the outside when being stretched to provide an entrance/exit guide panel 510 extending from a floor F of the vehicle, and an object on the inside or outside of a vehicle enters the inside of the vehicle or exits to the outside through the lower door while being guided through the entrance/exit guide panel 510 when the lower door 500 is stretched to enter the interior of the vehicle or exit to the outside.

The present disclosure relates to an entrance 100 for allowing various kinds of objects ranging from an ultra-small mobile object M to a seat S to enter and exit from the interior of the vehicle 10. Further, the size of the entrance 100 has to be changed according to objects of various sizes to allow the various objects to enter or exit from the vehicle, and a measure of utilizing a front surface of the vehicle as the entrance to realize a technology of connecting a parked vehicle to a housing R.

In this case, the front surface of the vehicle functions as the entrance 100, and the seat S of the vehicle may enter and exit from the interior of the vehicle directly through the entrance 100 of the front surface without having to pass through a rear trunk.

The entrance 100 formed on the front surface of the vehicle basically has a height that is opened from the floor F of the vehicle to the roof. Further, the entrance 100 is divided into an upper entrance and a lower entrance, and the upper entrance opens and closes the upper gate 300 and the lower entrance opens and closes the lower door 500.

In detail, the upper gate 300 opens and closes an upper portion of the vehicle entrance 100 through a sliding operation or a rotation operation. Further, the lower door 500 is provided with a lower portion of the vehicle entrance 100 to provide an entrance/exit guide panel 510 that closes a lower portion of the vehicle entrance 100 when being received and is stretched from the lower portion of the vehicle entrance 100 to the outside to extend from the floor F of the vehicle when being stretched. Through this, the object on the inside or outside of the vehicle may be guided through the entrance/exit guide panel 510 when the lower door 500 is stretched and may enter or exit from the interior of the vehicle.

FIG. 2 is a conceptual view of the vehicle entrance system according to the embodiment of the present disclosure, and the area of the upper gate 300 may be larger than the area of the lower door 500. That is, the upper gate 300 and the lower door 500 may be opened together such that an object may be loaded in or unloaded from the vehicle when the height or the size of the object is large. Alternatively, only the lower door 500 may be opened such that an object may simply enter or exit from the vehicle when the object is an ultra-small mobile object M which is small, whereby the entrance of the vehicle can be effectively managed and a phenomenon in which the entrance 100 of the vehicle is unnecessarily fully opened can be prevented.

Further, the upper gate 300 may be connected to an edge of the vehicle entrance 100 through a link 320, and an upper portion of the vehicle entrance 100 may be opened and closed through rotation and sliding of the link 320. A hinge structure may be installed at an upper end of the upper gate 300 such that the upper gate 300 may be opened and closed in a pivotal manner, but even in this case, a larger space may be necessary on the upper side of the vehicle.

Accordingly, the upper gate 300 may be opened and closed in a sliding manner such that the upper gate 300 overlaps an upper portion of the roof of the vehicle when the upper gate 300 is opened, and may constitute a front windshield glass of the vehicle when the upper gate 300 is closed.

A lower end of the link 320 is connected to the vehicle body and an upper end of the link 320 is connected to the upper gate 300 such that the link 320 supports the upper gate 300, and the link 320 tilts the upper gate 300 first when the upper gate 300 is opened and the upper gate 300 is slid rearwards in this state to be opened.

Meanwhile, the lower end of the lower door 500 is hinge-connected (520) to the lower end of the vehicle entrance and a lower portion of the vehicle entrance 100 may be opened and closed through rotation of the lower door 500. The size of the lower door 500 is small such that a large space is not necessary on the front side of the vehicle, and when the lower door 500 is stretched due to rotation thereof, the lower door 500 constitutes an inclined surface to connect the floor F and the ground surface G of the vehicle such that one connected surface is naturally defined.

FIG. 3 is a view illustrating the lower door of the vehicle entrance system according to the embodiment of the present disclosure. The lower door 500 is hinge-connected (520) to the lower end of the vehicle entrance. Through this, the lower entrance is opened and closed through rotation thereof.

Further, the lower door 500 is provided with a detection sensor 560, the detection sensor 560 may measure a spacing distance between the lower door 500 and the ground surface by using ultrasonic waves and the like, and the opening degree of the lower door 500 may be controlled according to the measurement result of the detection sensor 560. That is, the detection sensor 560 that measures a distance in a process of opening the lower door 500 is provided to measure the distance between the lower door 500 and the ground surface, and damage to the lower door 500 is prevented by controlling the opening degree of the lower door 500 through the measured value, and the lower door 500 is controlled to be opened to be sufficiently close to the ground surface.

Further, the upper end of the lower door 500 may become close to the ground surface or is supported by the ground surface when the lower door 500 is opened, whereby the entrance/exit guide panel 510 may form an inclined surface that extends from the floor F of the vehicle to the lower side of the outside. That is, a surface of the lower door 500, which is close to the interior of the vehicle constitutes the entrance/exit guide panel 510 such that the mobile object M, the seat S, or a passenger may easily get on or off the vehicle through the entrance/exit guide panel 510 that defines the inclined surface.

Further, the lower door 500 is provided with a locking structure 540 at a point corresponding to the vehicle body to be locked in the vehicle body when the lower door 500 is closed such that the entrance 100 is completely closed.

FIGS. 4 and 5 are views illustrating a utilization state of the vehicle entrance system according to the embodiment of the present disclosure. The present disclosure may further include a controller 30 that controls the upper gate 300 and the lower door 500 such that the upper gate 300 and the lower door 500 may be opened and closed together or independently. A controller 30 according to an exemplary embodiment of the present disclosure may be implemented by an algorithm configured to control operations of various elements of the vehicle, a nonvolatile memory (not illustrated) configured to store data and a software instruction for reproducing the algorithm, and a processor (not illustrated) configured to perform an operation, which will be described below, by executing the software instruction stored in the memory. Here, the memory and the processor may be implemented by individual chips. Alternatively, the memory and the processor may be implemented by an integrated single chip, and the processor may take the form of one or more processors.

The controller 30 identifies the kind of an object that approaches the entrance 100 of the vehicle through sensors installed in the upper gate 300, the lower door 500, or other parts of the vehicle. This may be recognized through photographing by a camera and the like, and an object may be recognized through various kinds of communications.

Further, when the controller 30 recognizes the kind of an object, the controller 30 controls the upper gate 300 and the lower door 500 to be opened and closed together or independently according to the size of the object.

That is, as in FIG. 4, when the seat S of the vehicle enters or exits from the vehicle, the upper gate 300 and the lower door 500 are opened and closed together, and as in FIG. 5, when the mobile object M enters or exits from the vehicle, only the lower door 500 is opened.

FIG. 4 illustrates that the vehicle is connected to a house R, and in this case, the living room of the house and the floor of the vehicle are connected to each other by opening the upper gate 300, connecting the entrance D of the house R and the vehicle, and opening the lower door 500. Further, the seat S on the inside of the vehicle may enter the outside of the vehicle, that is, the interior of the house.

FIG. 5 illustrates the entrance of the ultra-small mobile object M, and in this case, only the lower door 500 of the vehicle is opened, and a holder structure capable of mounting the mobile object M may be provided on the lower side of the inside of the entrance of the vehicle.

Further, the controller 30 may receive a command through communication, in addition to direct detection of a sensor to control the upper gate 300 and the lower door 500. Further, the controller 30 may authenticate an object on the outside. When the object is an external object that is allowed to enter and exit from the vehicle based on authentication, the lower door 500 may be controlled to be opened. Further, it may be determined whether the upper gate 300 is opened according to the kind of the object on the outside or the authentication result. In detail, the controller 30 may maintain the closed state of the upper gate 300 and open the lower door 500 when the size of the object on the outside is a predetermined size or less, and the controller 30 may open the upper gate 300 and adjust the opening degree of the upper gate 300 according to the size of the object on the outside when the size of the object on the outside is a predetermined size or more.

Meanwhile, FIG. 6 is a view illustrating a process of adjusting the road clearance of the vehicle by the vehicle entrance system according to the embodiment of the present disclosure. The controller 30 may control the road clearance of the vehicle body by comparing the height of a connection point of the lower door 500 and the vehicle body and the height of the ground surface. That is, when the lower door 500 is opened, the height of a floor F of the vehicle and the height of a point of the ground surface, which is expected to contact and an end of the lower door 500, are compared. Further, in the comparison result, when the ground surface G is lower than the floor F of the vehicle, the road clearance of the vehicle is not changed, and when the ground surface is higher, the road clearance of the vehicle is made larger, whereby the lower door 500 may constitute the downwardly inclined surface when the lower door 500 is opened.

The road clearance of the vehicle may be adjusted through configurations such as an air suspension and the lower door 500 forms the downwardly inclined surface through adjustment of the road clearance, whereby the object may easily enter or exit from the vehicle and the lower door 500 may be opened. Further, because an end of the lower door 500 is supported by the ground surface, damage to the lower door 500 can be prevented and damage to the detection sensor 560 or the like can be prevented.

FIG. 7 is a flowchart of a method for controlling a vehicle entrance system according to an embodiment of the present disclosure. In the method for controlling a vehicle entrance system of the present disclosure, a step of detecting an approach of an object on the inside or outside of a vehicle and detecting a request for entrance and exit thereof is performed (S100). Further, if necessary, the road clearance of the vehicle is adjusted (S200). Further, the kind of the object that is requested to enter or exit from the vehicle or the kind of the detected information is recognized (S300), and accordingly, a step of determining whether the upper gate or the lower door is opened is performed (S400). If the object is an ultra-small mobile object, only the lower door is opened (S420), and otherwise, the upper gate is also opened together with the lower door (S440). If the opening is completed, after the completion of the entrance or exit is detected (S500 and S600), the entrance is closed (S700).

Further, in the step of determining the opening, whether the upper gate is opened, whether the lower door is opened, and the opening degree of the upper gate when the upper gate is opened may be determined. Although a process of an external object entering the interior of the vehicle has been described as an example in the corresponding embodiment, a similar method may be performed when an object on the side of the vehicle exits from the vehicle.

According to the vehicle entrance system and the control method of the present disclosure, the entrance of the vehicle is divided into an upper side and a lower side, which are controlled to be opened and closed independently and the seat of the vehicle or the mobile object can freely enter and exit from the vehicle to be loaded or unloaded.

The disclosed embodiments of the present disclosure do not limit the technical spirit of the present disclosure but are illustrative, and the scope of the technical spirit of the present disclosure is not limited by the embodiments of the present disclosure. The scope of the present disclosure should be construed by the claims, and it will be understood that all the technical spirits within the equivalent range fall within the scope of the present disclosure.

What is claimed is:

1. A vehicle entrance system comprising:
an upper gate configured to open and close an upper portion of a vehicle entrance; and
a lower door provided at a lower portion of the vehicle entrance, and configured to close the lower portion of the vehicle entrance or be stretched from the lower portion of the vehicle entrance to the outside of the vehicle.

2. The vehicle entrance system of claim 1, wherein the lower door is stretched and the upper gate and the lower door are opened and closed simultaneously or independently to allow an object to enter the inside of a vehicle or to exit to the outside of the vehicle through the lower door.

3. The vehicle entrance system of claim 1, wherein an area of the upper gate is larger than an area of the lower door.

4. The vehicle entrance system of claim 1, wherein the upper gate is connected to an edge of the vehicle entrance through a link, and the upper portion of the vehicle entrance is opened and closed through rotation and sliding of the link.

5. The vehicle entrance system of claim 1, wherein a lower end of the lower door is hinge-connected to a lower end of the vehicle entrance, and the lower portion of the vehicle entrance is opened and closed through rotation of the lower door.

6. The vehicle entrance system of claim 1, wherein the lower door is provided with a detection sensor, the detection sensor measures a spacing distance between the lower door and a ground surface, and an opening degree of the lower door is controlled according to a measurement result of the detection sensor.

7. The vehicle entrance system of claim 1, wherein the lower door provides an entrance/exit guide panel extending from a floor of a vehicle, and an inclined surface extending from the floor of the vehicle to a lower side of the outside is defined by the entrance/exit guide panel as an upper end of the lower door approaches the ground surface or is supported by the ground surface when the lower door is opened.

8. The vehicle entrance system of claim 1, further comprising:
a controller configured to control the upper gate and the lower door to be opened and closed together or independently.

9. The vehicle entrance system of claim 8, wherein the controller controls a road clearance of a vehicle by comparing a height of a connection point of the lower door and a vehicle body and a height of the ground surface.

10. The vehicle entrance system of claim 8, wherein the controller authenticates an object and controls the lower door to be opened when the object is permitted for entrance or exit.

11. The vehicle entrance system of claim 10, wherein the controller determines whether to open the upper gate according to the kind of the object or an authentication result.

12. The vehicle entrance system of claim 10, wherein when a size of the object outside of the vehicle is a predetermined size or less, the controller controls the upper gate to be maintained closed and the lower door to be opened.

13. The vehicle entrance system of claim 10, wherein when a size of the object is a predetermined size or more, the controller opens the upper gate and adjusts an opening degree of the upper gate according to the size of the object outside of the vehicle.

14. The vehicle entrance system of claim 1, wherein the vehicle entrance is provided on a front surface of a vehicle.

15. A method for controlling the vehicle entrance system of claim 1, the method comprising:
detecting a request for entrance of an object;
determining whether the upper gate or the lower door is opened according to the kind of the object that is permitted for entrance and exit or the kind of detected information; and
controlling opening and closing of the upper gate or the lower door.

16. The method of claim 15, wherein the determining of whether the upper gate or the lower door is opened comprises determining whether the upper gate is opened, whether the lower door is opened, and an opening degree when the upper gate is opened.
